(19) United States
(12) Patent Application Publication
(10) Pub. No.: US 2016/0299698 A1
(43) Pub. Date: Oct. 13, 2016

(54) REALM PARTITIONING IN HARD DRIVES

(71) Applicant: HGST Netherlands B.V., Amsterdam (NL)

(72) Inventor: David R. Hall, Rochester, MN (US)

(21) Appl. No.: 14/683,917

(22) Filed: Apr. 10, 2015

(51) Int. Cl. G06F 3/06

(52) U.S. Cl. CPC G06F 3/0608; G06F 3/0644; G06F 3/0665; G06F 3/0685

(57) ABSTRACT

In general, techniques are described for partitioning a storage media into realms. The storage media may be divided into a plurality of physical regions, where each physical region from the plurality of physical regions is associated with one or more logical block addresses (LBAs). A controller configured to perform techniques described herein may determine a plurality of realms in the storage media. Each realm from the plurality of realms may comprise a distinct range of the plurality of LBAs. Each physical region of the plurality of physical regions associated with a respective logical block address within the respective range of logical block addresses for the respective realm is further associated with the respective realm. The controller may further dynamically define one or more characteristics of each physical region associated with each realm from the plurality of realms.

### TECHNICAL FIELD

The disclosure relates to shingled magnetic recording hard disk drives.

### BACKGROUND

Shingled magnetic recording (SMR) hard disk drives (HDDs) are organized using physical regions to which a hard drive controller can write data. The physical regions may be configured to be any size up to the storage capacity of the SMR HDD and the size of the physical region is typically inversely proportional to the number of physical regions. If these physical regions in an SMR HDD are larger, a controller may easily write data sequentially to the zones, but re-writes and defragmentation operations are slow due to the large amount of data that must be moved around within each zone. Configuring an SMR HDD to include a higher number of smaller physical regions enables certain benefits as compared to including a lower number of larger physical regions. For example, including a higher number of small physical regions may provide flexibility within the drive when the controller performs multiple sequential writes or when re-writing data within the SMR HDD. However, including a higher number of smaller physical regions introduces multiple inefficiencies. Due to the higher number of physical regions, it may take longer to perform a seek operation when moving from one physical region to another physical region and the controller may need to more frequently defragment the physical regions. Further, because each track of physical regions is separated by a number of empty tracks, called guard bands, a higher the number of physical regions results in additional guard bands and an increased percentage of the available space of the SMR HDD unusable for storing data.

### SUMMARY

In one example, the disclosure is directed to a device comprising a controller and a storage media. The storage media may be divided into a plurality of physical regions, with each physical region being associated with one or more logical block addresses. The controller may be configured to determine a plurality of realms in the storage media. Each realm from the plurality of realms may comprise a distinct range of the logical block addresses. Each physical region of the plurality of physical regions associated with a respective logical block address within the respective range of logical block addresses for the respective realm is further associated with the respective realm. The controller may be further configured to dynamically define one or more characteristics of each physical region associated with each realm from the plurality of realms.

In another example, the disclosure is directed to a method comprising determining, by a controller, a plurality of realms in a storage media. Each physical region is associated with one or more logical block addresses. Each realm from the plurality of realms comprises a distinct range of the logical block addresses. Each physical region of the plurality of physical regions associated with a respective logical block address within the respective range of logical block addresses for the respective realm is further associated with the respective realm. The controller further dynamically defines one or more characteristics of each physical region associated with each realm from the plurality of realms.

In another example, the disclosure is directed to a system comprising means for writing data to storage media. The storage media may be divided into a plurality of physical regions, with each physical region being associated with one or more logical block addresses. The system may further comprise means for determining a plurality of realms in the storage media. Each realm from the plurality of realms may comprise a distinct range of the logical block addresses. Each physical region of the plurality of physical regions associated with a respective logical block address within the respective range of logical block addresses for the respective realm is further associated with the respective realm. The system may also comprise means for dynamically defining one or more characteristics of each physical region associated with each realm from the plurality of realms.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual and schematic block diagram illustrating an example storage environment in which a hard drive may function as a storage device for a host device, in accordance with one or more techniques of this disclosure.

FIG. 2 is a block diagram illustrating the controller and other components of the hard drive of FIG. 1 in more detail.

FIG. 3 is a conceptual diagram illustrating an example hard disk drive segmented into realms, in accordance with one or more techniques of this disclosure.

FIG. 4 is a conceptual table illustrating an example series of write operations on a realm, in accordance with one or more techniques of this disclosure.

FIG. 5 is a flow diagram illustrating an exemplary operation of a storage device controller in performing various aspects of the hard drive partitioning techniques described in this disclosure.

### DETAILED DESCRIPTION

In general, this disclosure describes techniques for grouping smaller sized physical regions of a shingled magnetic recording (SMR) hard disk drive (HDD) into realms, which may reduce the impact of including a higher number of smaller sized physical regions while still realizing the seek benefits of an SMR HDD having a smaller number of larger sized physical regions. An SMR HDD with smaller physical regions may see increased re-write and defragmentation performance with larger seek and initial write penalties due to the difficulty of writing large pieces of data contiguously. An SMR HDD with larger physical regions may be a more efficient configuration for write and seek operations, as data can more easily be contiguously written, although this benefit comes at the expense of decreased efficiency in re-write and defragmentation operations. An SMR HDD with larger physical regions requires moving a larger amount of data when re-writes and defragmentation is occurring, slowing the overall write speed.

In using techniques of this disclosure, an SMR HDD may be organized into a larger amount of smaller sized physical regions further grouped into realms. By having smaller physical regions, an SMR HDD with realms may realize the benefits of increased re-write and defragmentation performance within the physical regions themselves. The additional logical structure of a realm further adds another level at which defragmentation can occur, which may enable an SMR HDD to run defragmentation within a realm so that a controller of the SMR HDD can write a larger piece of data contiguously within a realm without defragmenting the entirety of the SMR HDD. Even further, an SMR HDD that implements the grouping structure of a realm may realize decreased seek times, as a magnetic read head of the SMR HDD may move within realms to seek for exception data. In this way, an SMR HDD with a realm structure as disclosed herein can realize the benefits of both smaller physical regions and larger physical regions while, in at least some examples, reducing the negative impact that each may have on performance and overhead.

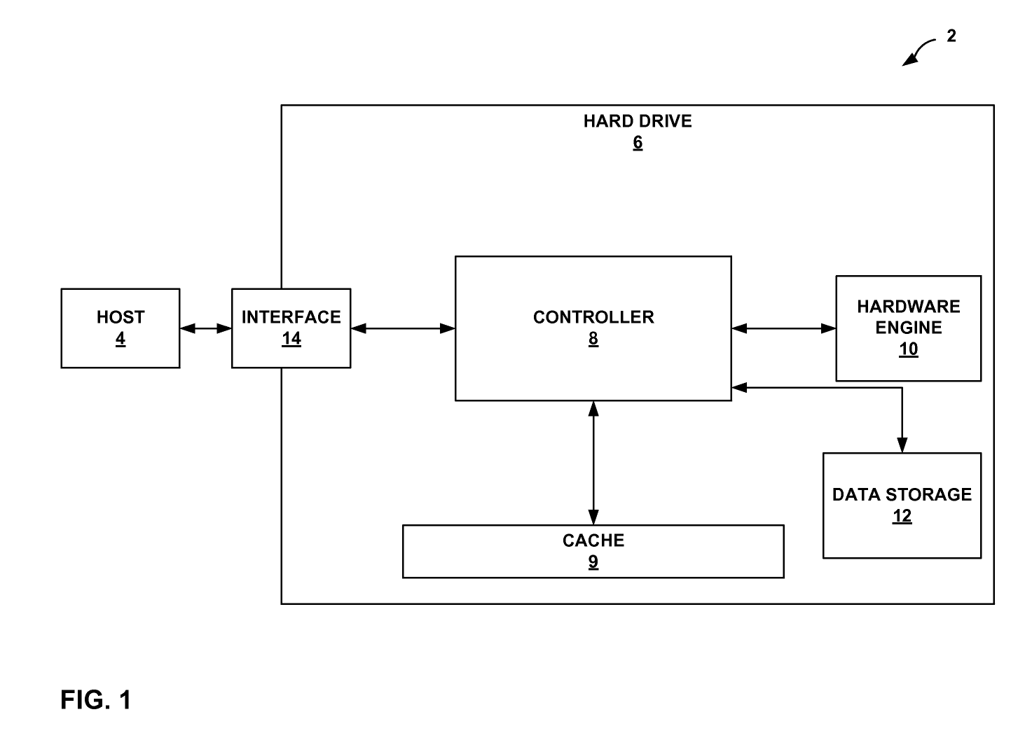

FIG. 1 is a conceptual and schematic block diagram illustrating an example storage environment 2 in which hard drive 6 may function as a storage device for host device 4, in accordance with one or more techniques of this disclosure. For instance, host device 4 may utilize non-volatile memory devices included in hard drive 6 to store and retrieve data. In some examples, storage environment 2 may include a plurality of storage devices, such as hard drive 6, which may operate as a storage array. For instance, storage environment 2 may include a plurality of hard drives 6 configured as a redundant array of inexpensive/independent disks (RAID) that collectively function as a mass storage device for host device 4. While techniques of this disclosure generally refer to storage environment 2 and hard drive 6, techniques described herein may be performed in any storage environment that utilizes tracks of data.

Storage environment 2 may include host device 4 which may store and/or retrieve data to and/or from one or more storage devices, such as hard drive 6. As illustrated in FIG. 1, host device 4 may communicate with hard drive 6 via interface 14. Host device 4 may comprise any of a wide range of devices, including computer servers, network attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, and the like. Typically, host device 4 comprises any device having a processing unit, which may refer to any form of hardware capable of processing data and may include a general purpose processing unit (such as a central processing unit (CPU), dedicated hardware (such as an application specific integrated circuit (ASIC)), configurable hardware such as a field programmable gate array (FPGA) or any other form of processing unit configured by way of software instructions, microcode, firmware or the like. For the purpose of executing techniques of this disclosure, host device 4 may send write requests to controller 8 via interface 14 for the purpose of re-writing data stored in a first group of one or more tracks to a SMR region using techniques described herein.

As illustrated in FIG. 1 hard drive 6 may include a controller 8, a cache 9, a hardware engine 10, data storage device 12, and an interface 14. In some examples, hard drive 6 may include additional components not shown in FIG. 1 for ease of illustration purposes. For example, hard drive 6 may include power delivery components, including, for example, a capacitor, super capacitor, or battery; a printed board (PB) to which components of hard drive 6 are mechanically attached and which includes electrically conductive traces that electrically interconnect components of hard drive 6, and the like. In some examples, the physical dimensions and connector configurations of hard drive 6 may conform to one or more standard form factors. Some example standard form factors include, but are not limited to, 3.5″ hard disk drive (HDD), 2.5″ HDD, or 1.8″ HDD.

In some examples, cache 9 may store information for processing during operation of hard drive 6. In some examples, cache 9 is a temporary memory, meaning that a primary purpose of cache 9 is not long-term storage. Cache 9 on hard drive 6 may configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

In some examples, hard drive 6 may be a shingled magnetic recording (SMR) hard drive. With SMR, relatively wide tracks are written to hard drive 6 and successively written data tracks partially overlap the previously written data tracks. This increases the density of hard drive 6 by packing the tracks closer together. When energized, a magnetic field emanating from the poles writes and erases data by flipping the magnetization of small regions, called bits, on spinning platters, such as data storage 12, directly below. SMR hard drives may enable high data densities and are particularly suited for continuous writing/erasing.

Data storage 12 may be configured to store larger amounts of information than cache 9. Data storage 12 may further be configured for long-term storage of information as non-volatile memory space and retain information after power on/off cycles. Examples of non-volatile memories include magnetic hard disks, optical disks, floppy disks, flash memories, or forms of electrically programmable memories (EPROM) or electrically erasable and programmable (EEPROM) memories. Data storage 12 may be one or more magnetic platters in hard drive 6, each platter containing one or more regions of one or more tracks of data.

In general, where hard drive 6 is an SMR hard drive, data storage 12 portion of hard drive 6 may contain a plurality of physical regions. A physical region is an area of contiguous, overlapping magnetic tracks that are parallel to one another. Each physical region may be separated by a guard band, or a set of one or more magnetic tracks that do not store data. Logical block addresses may be a logical interpretation of a location of a physical region on hard drive 6. Each region may be polymorphic, in that each region can have arbitrary attributes. For example, a region may hold the valid contents of four logical spans (LSpans). A logical span is a span, or range, of sequential LBAs that map to neighboring portions of the overlapping magnetic tracks inside a physical region. The logical space in LBAs of an LSpan could be the size of a physical region, but since all of it might not be valid, controller 8 may compact multiple spans into a single physical region. In other words, a series of LBAs that make up an LSpan may map to a physical space that is the size of the area of contiguous, overlapping magnetic tracks in the physical region, or some smaller portion of the area of contiguous, overlapping magnetic tracks in the physical region. In other examples, a single LSpan may have a size that is larger than a physical region. As such, a single LSpan may be stored across multiple physical regions.

In some examples where hard drive 6 is an SMR hard drive, data storage 12 portion of hard drive 6 may comprise two at least two specific types of regions: I-regions and E-regions. Tracks on a disk surface may be organized into a plurality of shingled regions, called I-regions. The direction of the shingled writing for an I-region can be from an inner diameter (ID) to an outer diameter (OD) or from OD to ID. The disk may also be shingled in both directions on the same surface, with the two zones meeting approximately at the mid-diameter point. The write performance of hard drive 6 correlates with the number of tracks grouped together in each region such that, as the number of tracks increases, the write performance of hard disk 6 may decrease when the writes are random or smaller than the size of the grouped tracks. Once written in the shingled structure, an individual track may not be able to be updated in place because re-writing the track in place may overwrite and destroy the data in the overlapping tracks.

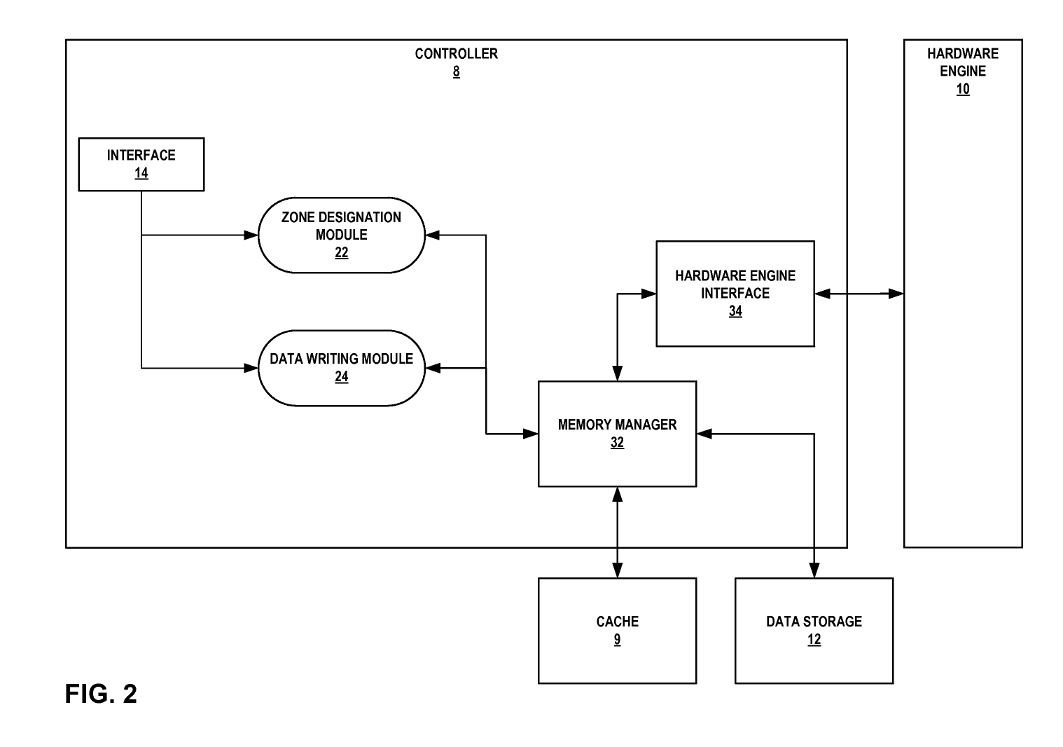

In an attempt to improve the performance of SMR drives, a portion of the magnetic media may be allocated to one or more so-called “exception regions” (E-regions) which are used as staging areas for data which will ultimately be written to an I-region. The E-region is sometimes referred to as an E-cache. Since most of the data in an SMR drive is expected to be stored sequentially in I-regions, the data records that are not currently stored in the I-regions can be thought of as “exceptions” to sequential I-region storage. However, each E-region consumes a portion of data storage 12 such that there is less space available for I-regions. As discussed with respect to FIG. 2, according to techniques of this disclosure, controller 8 may dynamically designate any physical region on hard drive 6 to be one of an I-region, an E-region, or, in some examples, a spare physical region.

Hard drive 6 may include interface 14 for interfacing with host device 4. Interface 14 may include one or both of a data bus for exchanging data with host device 4 and a control bus for exchanging commands with host device 4. Interface 14 may operate in accordance with any suitable protocol. For example, interface 14 may operate in accordance with one or more of the following protocols: advanced technology attachment (ATA) (e.g., serial-ATA (SATA), and parallel-ATA (PATA)), Fibre Channel, small computer system interface (SCSI), serially attached SCSI (SAS), peripheral component interconnect (PCI), and PCI-express (PCIe). The electrical connection of interface 14 (e.g., the data bus, the control bus, or both) is electrically connected to controller 8, providing electrical connection between host device 4 and controller 8, allowing data to be exchanged between host device 4 and controller 8. In some examples, the electrical connection of interface 14 may also permit hard drive 6 to receive power from host device 4.

In the example of FIG. 1, hard drive 6 includes hardware engine 10, which may represent the hardware responsible for interfacing with the storage medium. Hardware engine 10 may, in the context of a platter-based hard drive, represent the magnetic read/write head and the accompanying hardware to configure, drive and process the signals sensed by the magnetic read/write head.

Hard drive 6 includes controller 8, which may manage one or more operations of hard drive 6. Controller 8 may interface with host device 4 via interface 14 and manage the storage of data to and the retrieval of data from data storage 12 accessible via hardware engine 10. Controller 8 may, as one example, manage writes to and reads from the memory devices, e.g., Negated AND (NAND) flash memory chips or a hard disk drive platter. In some examples, controller 8 may be a hardware controller. In other examples, controller 8 may be implemented into hard drive 6 as a software controller. Controller 8 may further include one or more features that may perform techniques of this disclosure, such as atomic write-in-place module 16.

Host 4 may, in this respect, interface with various hardware engines, such as hardware engine 10, to interact with various sensors. Host 4 may execute software, such as the above noted operating system, to manage interactions between host 4 and hardware engine 10. The operating system may perform arbitration in the context of multi-core CPUs, where each core effectively represents a different CPU, to determine which of the CPUs may access hardware engine 10. The operating system may also perform queue management within the context of a single CPU to address how various events, such as read and write requests in the example of hard drive 6, issued by host 4 should be processed by hardware engine 10 of hard drive 6.

Physical regions within a certain range of logical block addresses may be grouped into a realm, which can be arranged and operated independent of other realms of the SMR HDD. The physical regions in each realm may be used interchangeably as E-regions, I-regions, or spare regions. Techniques of this disclosure may reduce seek penalties by aggregating writes to multiple physical regions to a single realm. Further, because each physical region within a realm may be used as an E-region, an I-region, or a spare region, techniques describe herein may provide a more flexible mechanism for expandable E-Regions. By dividing a SMR HDD into multiple realms, the benefits recognized by a small storage device, such as reduced seek penalties and simplified defragmentation, can be realized on a storage device with a higher storage capacity while still utilizing smaller shingled regions and smaller guard bands between the shingled regions.

Techniques of this disclosure may enable controller 8 to partition hard drive 6 using realm structures. In addition to the description given above with regards to data storage 12, data storage 12 may be divided into a plurality of physical regions. Each physical region from the plurality of physical regions may be associated with one or more logical block addresses. Generally, each physical region of the plurality of physical regions is the same size, although there could be examples that implement techniques of this disclosure where different physical regions have different sizes. In some examples, each physical region is 256 MB in size. However, in other examples, a physical region may be smaller in size (e.g., 128 MB) or larger in size (e.g., 8 GB to 100's of GB0 than 256 MB. Logical block addressing (LBA) is a common scheme used for specifying the location of physical regions on computer storage devices and secondary storage systems, such as hard disks. LBA is a particularly simple linear addressing scheme; physical regions are located by an integer index, with the first physical region being LBA 0, the second LBA 1, and so on. In some examples, the physical regions are arranged on data storage 12 such that the lowest LBA is on an outer diameter and the highest LBA is on the inner diameter with the physical regions arranged in increasing order of LBA as the physical region becomes closer to the inner diameter. In other examples, this arrangement is reversed, with the lowest LBA on an inner diameter and the highest LBA on the outer diameter with the physical regions arranged in increasing order of LBA as the physical region becomes closer to the outer diameter. Although this example describes a 1:1 mapping of physical regions to LBAs, examples can exist where multiple LBAs are associated with the same physical region. In other examples, a single LBA may refer to data that is stored across multiple physical regions, meaning each physical region has the same LBA.

Controller 8 may further determine a plurality of realms in data storage 12. Each realm from the plurality of realms may include a distinct range of the logical block addresses. Further, each physical region of the plurality of physical regions associated with a respective logical block address within the respective range of logical block addresses for the respective realm is further associated with the respective realm. In other words, an example system may utilize four million physical regions in data storage 12. If there are twenty realms determined for data storage 12, then the first realm may contain physical regions with logical block addresses between 0 and 199,999, the second realm may contain physical regions with logical block addresses between 200,000 and 399,999, etc. It should be understood that other examples may have more than four million physical regions or less than four million physical regions in combination with more than twenty realms or less than twenty realms. The example using four million physical regions and twenty realms is for example purposes only. Although this example describes a 1:1 mapping of physical regions to LBAs, examples can exist where multiple LBAs are associated with the same physical region. In other examples, a single LBA may refer to data that is stored across multiple physical regions, meaning each physical region has the same LBA. In such examples where there is not a 1:1 mapping of physical regions, each realm contains a range of LBAs.

Controller 8 may be configured to dynamically define one or more characteristics of each physical region associated with each realm from the plurality of realms of data storage 12. The one or more characteristics may be any characteristic that influences the operation of hard drive 6 or the handling of data stored within the respective physical region, such as storage duration, encryption, or the type of data that can be stored in the respective physical region, among other things. In other words, the regions that are mapped according to the physical regions and the logical block addresses may be polymorphic, taking on arbitrary attributes as required by the computing device containing hard drive 6 and the data being stored in the respective region. In some specific examples, controller 8 may be configured to dynamically designate each physical region in each realm of the plurality realms to be one of an I-region, an E-region, or a spare physical region. As described above, an E-region may be configured for temporary storage. Further, an I-region may be configured to store data more permanently, such as long-term storage. A spare physical region may be a physical region of the plurality of physical regions that is configured to not store any data. Further detail in regards to how controller 8 designates the physical regions to be an I-region or an E-region are shown with respect to FIG. 2.

By partitioning data storage 12 into realms, seek penalties may be reduced by keeping writes to multiple physical regions within the same realm, where the physical regions all have a similar physical location. Further, by allowing the physical regions in each realm to be interchangeably used as an E-region, an I-region, or a spare region, or even to have polymorphic attributes, techniques describe herein may provide a more flexible mechanism for expandable E-Regions and deal with FTI in a more elegant manner, which further allows smaller shingled regions to be utilized. Further, since each realm can be used as storage independently of other realms, techniques described herein may simplify defragmentation procedures and improve FTI handling. Larger streamed writes (i.e. >1 GB streamed writes) with smaller physical regions will no longer occur in the same physical regions, further improving sequential bypass performance. By dividing hard drive 6 into multiple realms, the benefits recognized by a small storage device, such as reduced seek penalties and simplified defragmentation, can be realized on a storage device with a higher storage capacity while still utilizing smaller shingled regions and smaller guard bands between the shingled regions.

FIG. 2 is a block diagram illustrating controller 8 and other components of hard drive 6 of FIG. 1 in more detail. In the example of FIG. 2, controller 8 includes interface 14, zone designation module 22, data writing module 24, memory manager unit 32, and hardware engine interface unit 34. Memory manager unit 32 and hardware engine interface unit 34 may perform various functions typical of a controller on a hard drive. For instance, hardware engine interface unit 34 may represent a unit configured to facilitate communications between the hardware controller 8 and the hardware engine 10. Hardware engine interface unit 34 may present a standardized or uniform way by which to interface with hardware engine 10. Hardware engine interface 34 may provide various configuration data and events to hardware engine 10, which may then process the event in accordance with the configuration data, returning various different types of information depending on the event. In the context of an event requesting that data be read (e.g., a read request), hardware engine 10 may return the data to hardware engine interface 34, which may pass the data to memory manager unit 32. Memory manager unit 32 may store the read data to cache 9 and return a pointer or other indication of where this read data is stored to hardware engine interface 34. In the context of an event involving a request to write data (e.g. a write request), hardware engine 10 may return an indication that the write has completed to hardware engine interface unit 34. In this respect, hardware engine interface unit 34 may provide a protocol and handshake mechanism with which to interface with hardware engine 10.

Controller 8 includes various modules, including zone designation module 22 and data writing module 24. The various modules of controller 8 may be configured to perform various techniques of this disclosure, including the technique described above with respect to FIG. 1. Zone designation module 22 and data writing module 24 may perform operations described herein using software, hardware, firmware, or a mixture of hardware, software, and firmware residing in and/or executing on hard drive 6.

Using zone designation module 22 and data writing module 24, controller 8 may perform techniques of this disclosure to partition and write data to data storage 12 of hard drive 6. As described above, data storage 12 may be divided into a plurality of physical regions. Each physical region from the plurality of physical regions may be associated with one or more logical block addresses. Generally, each physical region of the plurality of physical regions is the same size, although there could be examples that implement techniques of this disclosure where different physical regions have different sizes. In some examples, each physical region is 256 MB in size. However, in other examples, a physical region may be smaller in size (e.g., 128 MB) or larger in size (e.g., 8 GB to 100's of GB) than 256 MB. Logical block addressing (LBA) is a common scheme used for specifying the location of physical regions on computer storage devices and secondary storage systems, such as hard disks. LBA may be a particularly simple linear addressing scheme; physical regions are located by an integer index, with the first physical region being LBA 0, the second LBA 1, and so on. In some examples, the physical regions are arranged on data storage 12 such that the lowest LBA is on an outer diameter and the highest LBA is on the inner diameter with the physical regions arranged in increasing order of LBA as the physical region becomes closer to the inner diameter. In other examples, this arrangement is reversed, with the lowest LBA on an inner diameter and the highest LBA on the outer diameter with the physical regions arranged in increasing order of LBA as the physical region becomes closer to the outer diameter. Although this example describes a 1:1 mapping of physical regions to LBAs, examples can exist where multiple LBAs are associated with the same physical region. In other examples, a single LBA may refer to data that is stored across multiple physical regions, meaning each physical region has the same LBA. In such examples where there is not a 1:1 mapping of physical regions, each realm contains a range of LBAs.

Zone designation module 22 of controller 8 may further determine a plurality of realms in data storage 12 based on the respective logical block address of each physical region from the plurality of physical regions in data storage 12. Each realm from the plurality of realms may include a distinct range of the logical block addresses. Further, each physical region of the plurality of physical regions associated with a respective logical block address within the respective range of logical block addresses for the respective realm is further associated with the respective realm. In other words, an example system may utilize two million physical regions in data storage 12. If there are twenty-five realms determined for data storage 12, then the first realm may contain physical regions with logical block addresses between 0 and 79,999, the second realm may contain physical regions with logical block addresses between 80,000 and 159,999, etc. It should be understood that other examples may have more than two million physical regions or less than two million physical regions in combination with more than twenty-five realms or less than twenty-five realms. The example using two million physical regions and twenty-five realms is for example purposes only. Although this example describes a 1:1 mapping of physical regions to LBAs, examples can exist where multiple LBAs are associated with the same physical region. In other examples, a single LBA may refer to data that is stored across multiple physical regions, meaning each physical region has the same LBA. In such examples where there is not a 1:1 mapping of physical regions, each realm contains a range of LBAs.

Zone designation module 22 of controller 8 may be configured to dynamically define one or more characteristics of each physical region within each realm of data storage 12. The one or more characteristics may be any characteristic that influences the operation of hard drive 6 or the handling of data stored within the respective physical region, such as storage duration, encryption, or the type of data that can be stored in the respective physical region, among other things. In other words, the regions that are mapped according to the physical regions and the logical block addresses may be polymorphic, taking on arbitrary attributes as required by the computing device containing hard drive 6 and the data being stored in the respective region. In some specific examples, zone designation module 22 of controller 8 may be configured to dynamically designate each physical region in each realm of the plurality realms to be one of an I-region, an E-region, or a spare physical region. As described above, an E-region may be configured for temporary storage. Further, an I-region may be configured to store data more permanently, such as long-term storage.

In some examples, an entire physical region may be associated with a single, distinct logical block address. In other examples, a single physical region may be associated with multiple logical block addresses. In still other examples, multiple physical regions may be associated with the same logical block address. Each of these examples may exist in the same data storage 12 of hard drive 6. In other words, the presence of one configuration in data storage 12 of hard drive 6 does not exclude the remaining configurations from being present in the same data storage 12 of hard drive 6. Further, while a physical region may be associated with one or more logical block addresses at first, and a first corresponding realm, physical regions may be updated such that the physical regions are associated with different logical block addresses and, possibly, different realms. For example, a first physical region may be associated with a first logical block address associated with a first realm. Zone designation module 22 of controller 8 may update the first physical region such that the first physical region is not associated with the first logical block address and such that the first physical region is associated with a second logical block address different than the first logical block address. Responsive to the second logical block address being associated with a second realm different than the first realm, zone designation module 22 of controller 8 may determine that the first physical region is associated with the second realm, instead of the first realm.

A spare physical region is a physical region that is configured to not store any data. In other words, this allows for overprovisioning within data storage 12 of hard drive 6. By allowing for overprovisioning, a hard drive that is partitioned according to techniques of this disclosure may perform various effective defragmentation techniques, which will allow the hard drive to be in the most efficient state possible during its current configuration.

An example defragmentation procedure could include data writing module 24 of controller 8 causing memory manager unit 32 to move data written from a first physical region designated to be one of an I-region or an E-region to a first spare physical region of the one or more spare physical regions. Since zone designation module 22 of controller 8 can dynamically designate various physical regions to be one of an I-region, an E-region, or a spare physical region, controller 8 can move this data without losing the desired overprovisioning. For example, zone designation module 22 of controller 8 can designate the first physical region (i.e., the original location of the data that was previously designated to be one of an I-region or an E-region), which now does not contain any data, to be a spare physical region. Zone designation module 22 of controller 8 can further designate the first spare physical region (i.e., the spare physical region that now contains the data previously stored in the first physical region) to be one of an I-region or an E-region, typically based on whether the first physical region was previously designated to be an I-region or an E-region.

As described above, zone designation module 22 of controller 8 may also dynamically designate the one or more physical regions within each realm to be one of an I-region or an E-region. In doing so, zone designation module 22 of controller 8 designate a first physical region to be an E-region when the first physical region is not a spare physical region and there is no data written to the first physical region. Zone designation module 22 of controller 8 may also designate the first physical region to be an E-region when the first physical region is not a spare physical region and there is only temporary data or exception data written to the first physical region. Otherwise, zone designation module 22 may designate the first physical region to be an I-region when the first physical region is not a spare physical region and does not fall under any of the categories above for an E-region. In this way, hard drive 6 can allow for an expandable E-region within each realm of data storage 12, providing the optimal storage environment for each configuration of hard drive 6.

Zone designation module 22 of controller 8 may also modify existing E-regions to become I-regions. For example, data writing module 24 of controller 8 may write a first set of data to a physical region that was previously designated to be an E-region. The first set of data is not temporary data and is not exception data. Once this non-temporary, non-exception data is written to the physical region previously designated to be an E-region, zone designation module 22 may update the physical region by designating the physical region to be an I-region. In this way, hard drive 6 can dynamically alter the storage environment based on the information being stored in each physical region to dynamically provide the optimal storage environment for each configuration of hard drive 6.

Given the above configuration of realms, it may be possible that some realms may fill up before other realms. For instance, in general, any exception data related to data stored in an I-region of a particular realm may be stored in the same realm as the I-region. For example, a physical region in realm 13 of the above example may generate some exception data. That exception data may be written to a physical region to be designated as an E-region in realm 13. However, some data generates more exception data than others. For example, a large, continuous write that comprises multiple physical regions in realm 13 may generate multiple physical regions of exception data, causing realm 13 to have no free physical regions to which data writing module 24 can write exception data. In such an example, data writing module 24 of controller 8 may designate another realm of data storage 12 to be a buddy realm of realm 13.

For example, data writing module 24 may receive a request to write exception data to realm 13, the same realm that contains the I-region to which the exception data is related. Data writing module 24 may determine an amount of physical regions in the first realm that are not currently storing any data. Data writing module 24 may then determine whether the amount of physical regions in the first realm (i.e., realm 13) that are not currently storing any data is sufficient to store the exception data. If data writing module 24 determines that the amount of physical regions in realm 13 that are not currently storing any data is sufficient to store the exception data, data writing module 24 may write the exception data to one or more physical regions in realm 13. For example, if the exception data requires two physical regions, and realm 13 has three physical regions available, data writing module 24 may write the exception data to realm 13. However, if data writing module 24 determines that the amount of physical regions in realm 13 that are not currently storing any data is not sufficient to store the exception data, data writing module 24 may write the exception data to one or more physical regions in a second realm (i.e., the buddy realm) that has an amount of physical regions that are not currently storing any data that is sufficient to store the exception data. For example, if the exception data requires two physical regions, and realm 13 has only one physical region available, data writing module 24 may write the exception data to realm 10, which has twenty-seven physical regions available. Note that the buddy realm does not have to be a neighboring realm.

A buddy realm is configured to store any extraneous exception data for a realm that does not have sufficient space to store the extraneous exception data. However, if the buddy realm becomes full, the original realm that needed a buddy realm can obtain a second buddy realm. Continuing the previous example, data writing module 24 may receive a request to write exception data to realm 13, the same realm that contains the I-region to which the exception data is related. Since realm 13 does not have sufficient space for more exception data, data writing module 24 may then determine whether the amount of physical regions in the buddy realm (i.e., realm 10) that are not currently storing any data is sufficient to store the exception data. If data writing module 24 determines that the amount of physical regions in realm 10 that are not currently storing any data is sufficient to store the exception data, data writing module 24 may write the exception data to one or more physical regions in realm 10. For example, if the exception data requires five physical regions, and realm 10 has eight physical regions available, data writing module 24 may write the exception data for realm 13 to realm 10. However, if data writing module 24 determines that the amount of physical regions in realm 10 that are not currently storing any data is not sufficient to store the exception data for realm 13, data writing module 24 may write the exception data to one or more physical regions in a second buddy realm that has an amount of physical regions that are not currently storing any data that is sufficient to store the exception data. For example, if the exception data requires five physical regions, and realm 10 has only three physical regions available, data writing module 24 may write the exception data to realm 6, which has twelve physical regions available. Realm 6 would then be considered another buddy realm to realm 13.

Buddy realms further help the organization of data storage 12. While the realms allow multiple, expandable E-regions, some realms may fill sooner than others due to the reduced sizes for allocation. Using buddy realms will allow a read/write head to find exception data for a full realm with minimal seek penalties, maximizing the efficiency of a hard drive that uses techniques described herein.

By partitioning data storage 12 into realms, seek penalties may be reduced by keeping writes to multiple physical regions within the same realm, where the physical regions all have a similar physical location. Further, by allowing the physical regions in each realm to be interchangeably used as an E-region, an I-region, or a spare region, techniques describe herein may provide a more flexible mechanism for expandable E-Regions and deal with FTI in a more elegant manner, which further allows smaller shingled regions to be utilized. Further, since each realm can be used as storage independently of other realms, techniques described herein may simplify defragmentation procedures and improve FTI handling. Larger streamed writes (i.e. >1 GB streamed writes) with smaller physical regions will no longer occur in the same physical regions, further improving sequential bypass performance. By dividing hard drive 6 into multiple realms, the benefits recognized by a small storage device, such as reduced seek penalties and simplified defragmentation, can be realized on a storage device with a higher storage capacity while still utilizing smaller shingled regions and smaller guard bands between the shingled regions.

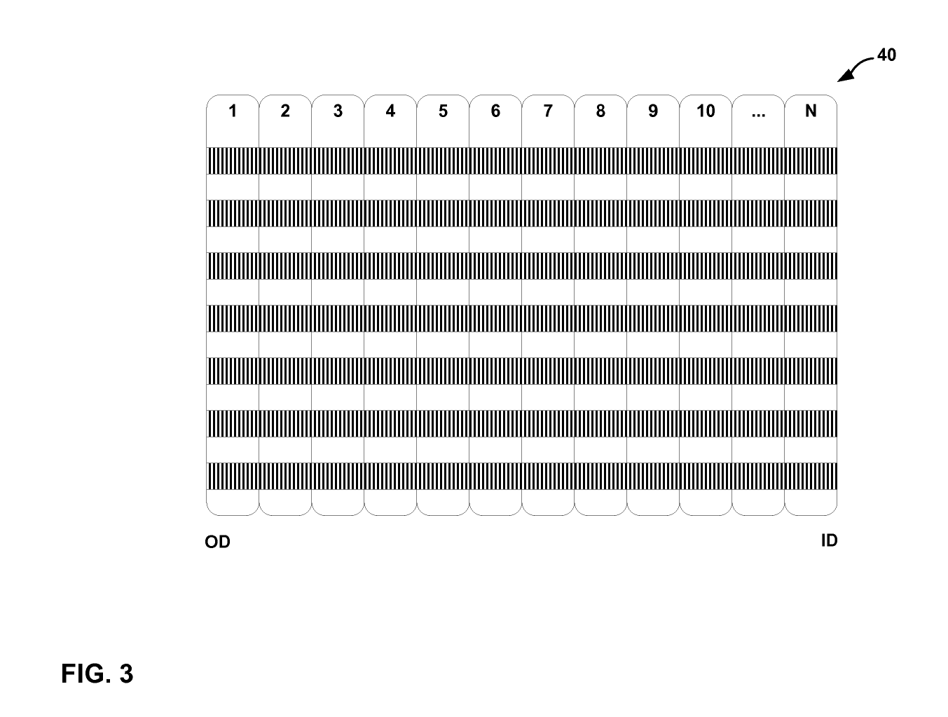

FIG. 3 is a conceptual diagram illustrating an example hard disk drive segmented into realms, in accordance with one or more techniques of this disclosure. Example data storage array 40 of FIG. 3 shows each realm labeled 1 through N. In some examples of data storage array 40, there may be fewer than fifteen realms, while other examples may have more than twenty-five different realms. Further, in example data storage array 40, the first realm, realm 1, that holds the physical regions with the smallest logical block addresses, is closest to an outer diameter of the hard disk, while the last realm, realm N, that holds the physical regions with the largest block addresses, is closest to the inner diameter of the hard disk.

In each realm, there are alternating “boxes” shown vertically. In this example, a physical region, whether it is an E-region, an I-region, or a spare physical region, is depicted as a box with a vertical line pattern. Further, in this example, the empty boxes between each physical region represent a guard band. A guard band represents one or more tracks of data between physical regions that do not have data of any kind written to them. Guard bands may reduce write errors in a shingled magnetic drive. In examples where physical regions were very large, guard bands could be as large as 64 tracks. However, using techniques of this disclosure to partition the hard disk into realms, guard bands can be reduced in size to as small as 1.5 tracks when used with 256 MB zones, meaning that the guard bands only take up about 0.795% of the available space in a hard disk. This enables hard drives that use the techniques disclosed herein to use smaller physical regions without suffering from penalties of larger guard bands.

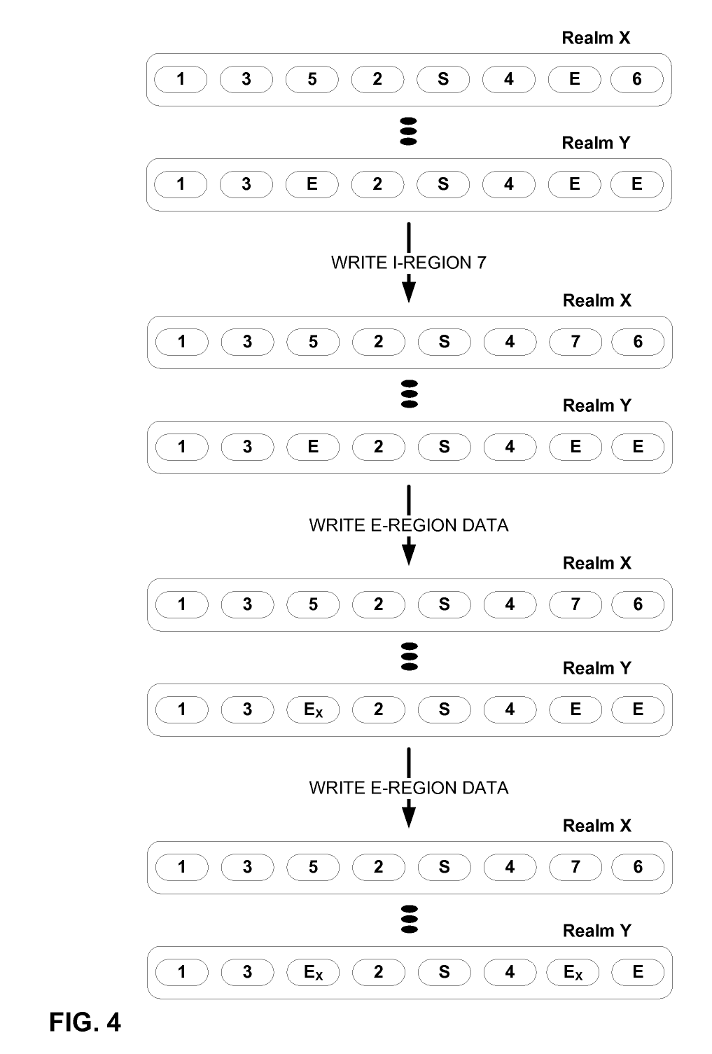

FIG. 4 is a conceptual table illustrating an example series of write operations on a realm in data storage 12 of hard drive 6, in accordance with one or more techniques of this disclosure. During various write operations, controller 8 may dynamically designate physical regions to be one of an I-region or an E-region. As described above, the physical regions may be polymorphic with arbitrary attributes. In the example of FIG. 4, the physical regions may take on the attributes of an I-region, an E-region, or a spare physical region. The example write sequence of FIG. 4 shows how physical regions can be dynamically classified to provide an optimal storage environment for data storage 12. In the example of FIG. 4, each realm is only shown with eight physical regions for simplicity. In other examples, each realm could have thousands of physical regions.

At time T1, Realm X includes six I-regions (i.e., physical regions 1, 3, 5, 2, 4, and 6). Realm X also includes one spare physical region (i.e., physical region S) and one E-region (i.e., physical region E). Realm Y includes four I-regions (i.e., physical regions 1, 3, 2, and 4). Realm Y also includes one spare physical region (i.e., physical region S) and three E-regions (i.e., physical regions E).

At time T2, data writing module 24 has received a request to write a set of data to a physical region in Realm X. The set of data is non-temporary data and non-exception data. Data writing module 24 may write this set of data in Realm X to the physical region that was previously used as an E-region in Realm X. Since this data is non-temporary data and non-exception data, zone designation module 22 of controller 8 may dynamically designate the previously designated E-region in Realm X to be an I-region (i.e., physical region 7).

At time T3, data writing module 24 has received a request to write exception data to a physical region in Realm X. The exception data may be associated with an I-region in Realm X, such as newly written physical region 7. Data writing module 24 may determine an amount of physical regions in Realm X that are not currently storing any data. Data writing module 24 may then determine whether the amount of physical regions in Realm X that are not currently storing any data is sufficient to store the exception data. In the example of FIG. 4 at time T3, Realm X does not have any physical regions that are not currently storing any data, outside of spare physical region S which must remain for defragmentation purposes. Realm X, however, needs one physical region available for data writing module 24 of controller 8 to write the exception data in the request. Since data writing module 24 determines that the amount of physical regions in Realm X that are not currently storing any data is not sufficient to store the exception data, data writing module 24 may write the exception data to one or more physical regions in a second realm (i.e., the buddy realm), Realm Y that has an amount of physical regions that are not currently storing any data that is sufficient to store the exception data. As now shown in time T3, the third physical region of Realm Y now contains exception data for Realm X, designated by E_{X}. Realm Y now includes four I-regions (i.e., physical regions 1, 3, 2, and 4), one spare physical region (i.e., physical region S), and three E-regions, one of which is associated with data in Realm X (i.e., physical regions E and E_{X}).

A buddy realm is configured to store any extraneous exception data for a realm that does not have sufficient space to store the extraneous exception data. However, if the buddy realm becomes full, the original realm that needed a buddy realm can obtain a second buddy realm. Continuing the previous example, at time T4, data writing module 24 receives a second request to write exception data to Realm X, the same realm that contains the I-region to which the exception data is related. Since Realm X does not have sufficient space for more exception data, data writing module 24 may then determine whether the amount of physical regions in the buddy realm (i.e., Realm Y) that are not currently storing any data is sufficient to store the exception data. Since there is sufficient space in Realm Y, data writing module 24 may write the exception data to a physical region in Realm Y. At time T4, Realm Y now includes four I-regions (i.e., physical regions 1, 3, 2, and 4), one spare physical region (i.e., physical region S), and three E-regions, two of which is associated with data in Realm X (i.e., physical regions E and E_{X}). However, if data writing module 24 had determined that the amount of physical regions in Realm Y that are not currently storing any data was not sufficient to store the exception data for realm 13, data writing module 24 may write the exception data to one or more physical regions in a second buddy realm that has an amount of physical regions that are not currently storing any data that is sufficient to store the exception data.

Buddy realms further help the organization of data storage 12. While the realms allow multiple, expandable E-regions, some realms may fill sooner than others due to the reduced sizes for allocation. Using buddy realms will allow a read/write head to find exception data for a full realm with minimal seek penalties, maximizing the efficiency of a hard drive that uses techniques described herein.

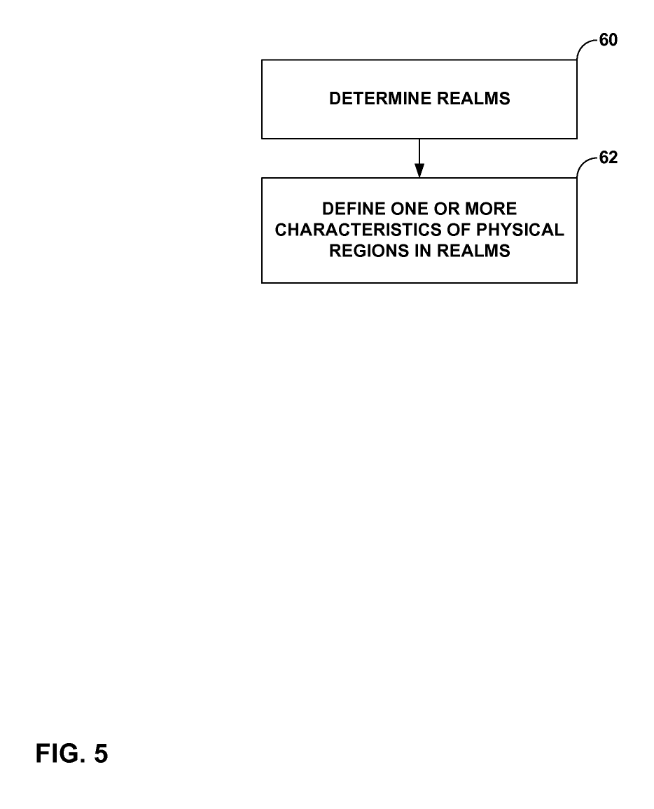

FIG. 5 is a flow diagram illustrating an exemplary operation of a storage device controller in performing various aspects of the hard drive partitioning techniques described in this disclosure. For example, a controller (e.g., controller 8) or a module within the controller (e.g., zone designation module 22 of controller 8) of a hard drive (e.g., hard drive 6) may be configured to determine a plurality of realms in storage media (e.g., data storage 12) (62). Each physical region is associated with one or more logical block addresses. Each realm from the plurality of realms comprises a distinct range of the logical block addresses. Each physical region of the plurality of physical regions associated with a respective logical block address within the respective range of logical block addresses for the respective realm is further associated with the respective realm. In other words, an example system may utilize one million, five hundred thousand physical regions in data storage 12. If there are fifteen realms determined for data storage 12, then the first realm may contain physical regions with logical block addresses between 0 and 149,999, the second realm may contain physical regions with logical block addresses between 150,000 and 299,999, etc. It should be understood that other examples may have more than one million, five hundred thousand physical regions or less than one million, five hundred thousand physical regions in combination with more than fifteen realms or less than fifteen realms. The example using one million, five hundred thousand physical regions and fifteen realms is for example purposes only. Although this example describes a 1:1 mapping of physical regions to LBAs, examples can exist where multiple LBAs are associated with the same physical region. In other examples, a single LBA may refer to data that is stored across multiple physical regions, meaning each physical region has the same LBA. In such examples where there is not a 1:1 mapping of physical regions, each realm contains a range of LBAs.

Zone designation module 22 of controller 8 may be further configured to dynamically define one or more characteristics of each physical region within each realm of data storage 12 (60). The one or more characteristics may be any characteristic that influences the operation of hard drive 6 or the handling of data stored within the respective physical region, such as storage duration, encryption, or the type of data that can be stored in the respective physical region, among other things. In other words, the regions that are mapped according to the physical regions and the logical block addresses may be polymorphic, taking on arbitrary attributes as required by the computing device containing hard drive 6 and the data being stored in the respective region. In some specific examples, controller 8 may be configured to dynamically designate each physical region in each realm of the plurality realms to be one of an I-region, an E-region, or a spare physical region. As described above, an E-region may be configured for temporary storage. Further, an I-region may be configured to store data more permanently, such as long-term storage.

In some examples, an entire physical region may be associated with a single, distinct logical block address. In other examples, a single physical region may be associated with multiple logical block addresses. In still other examples, multiple physical regions may be associated with the same logical block address. Each of these examples may exist in the same data storage 12 of hard drive 6. In other words, the presence of one configuration in data storage 12 of hard drive 6 does not exclude the remaining configurations from being present in the same data storage 12 of hard drive 6. Further, while a physical region may be associated with one or more logical block addresses at first, and a first corresponding realm, physical regions may be updated such that the physical regions are associated with different logical block addresses and, possibly, different realms. For example, a first physical region may be associated with a first logical block address associated with a first realm. Zone designation module 22 of controller 8 may update the first physical region such that the first physical region is not associated with the first logical block address and such that the first physical region is associated with a second logical block address different than the first logical block address. Responsive to the second logical block address being associated with a second realm different than the first realm, zone designation module 22 of controller 8 may determine that the first physical region is associated with the second realm, instead of the first realm.

A spare physical region is a physical region that is configured to not store any data. In other words, this allows for overprovisioning within data storage 12 of hard drive 6. By allowing for overprovisioning, a hard drive that is partitioned according to techniques of this disclosure may perform various effective defragmentation techniques, which will allow the hard drive to be in the most efficient state possible during its current configuration.

An example defragmentation procedure could include controller 8 or a second module of controller 8 (e.g., data writing module 24 of controller 8) causing a memory manager unit (e.g., memory manager unit 32) to move data written from a first physical region designated to be one of an I-region or an E-region to a first spare physical region of the one or more spare physical regions. Since zone designation module 22 of controller 8 can dynamically designate various physical regions to be one of an I-region, an E-region, or a spare physical region, controller 8 can move this data without losing the desired overprovisioning. For example, zone designation module 22 of controller 8 can designate the first physical region (i.e., the original location of the data that was previously designated to be one of an I-region or an E-region), which now does not contain any data, to be a spare physical region. Zone designation module 22 of controller 8 can further designate the first spare physical region (i.e., the spare physical region that now contains the data previously stored in the first physical region) to be one of an I-region or an E-region, typically based on whether the first physical region was previously designated to be an I-region or an E-region.

As described above, zone designation module 22 of controller 8 may also dynamically designate the one or more physical regions from the plurality of physical regions to be one of an I-region or an E-region. In doing so, zone designation module 22 of controller 8 designate a first physical region to be an E-region when the first physical region is not a spare physical region and there is no data written to the first physical region. Zone designation module 22 of controller 8 may also designate the first physical region to be an E-region when the first physical region is not a spare physical region and there is only temporary data or exception data written to the first physical region. Otherwise, zone designation module 22 may designate the first physical region to be an I-region when the first physical region is not a spare physical region and does not fall under any of the categories above for an E-region. In this way, hard drive 6 can allow for an expandable E-region within each realm of data storage 12, providing the optimal storage environment for each configuration of hard drive 6.

Zone designation module 22 of controller 8 may also modify existing E-regions to become I-regions. For example, data writing module 24 of controller 8 may write a first set of data to a physical region that was previously designated to be an E-region. The first set of data is not temporary data and is not exception data. Once this non-temporary, non-exception data is written to the physical region previously designated to be an E-region, zone designation module 22 may update the physical region by designating the physical region to be an I-region. In this way, hard drive 6 can dynamically alter the storage environment based on the information being stored in each physical region to dynamically provide the optimal storage environment for each configuration of hard drive 6.

Given this configuration of realms, it may be possible that some realms may fill up before other realms. For instance, in general, any exception data related to data stored in an I-region of a particular realm may be stored in the same realm as the I-region. For example, a physical region in realm 3 of the above example may generate some exception data. That exception data may be written to a physical region to be designated as an E-region in realm 3. However, some data generates more exception data than others. For example, a large, continuous write that comprises multiple physical regions in realm 3 may generate multiple physical regions of exception data, causing realm 3 to have no free physical regions to which data writing module 24 can write exception data. In such an example, data writing module 24 of controller 8 may designate another realm of data storage 12 to be a buddy realm of realm 3.

For example, data writing module 24 may receive a request to write exception data to realm 3, the same realm that contains the I-region to which the exception data is related. Data writing module 24 may determine an amount of physical regions in the first realm that are not currently storing any data. Data writing module 24 may then determine whether the amount of physical regions in the first realm (i.e., realm 3) that are not currently storing any data is sufficient to store the exception data. If data writing module 24 determines that the amount of physical regions in realm 3 that are not currently storing any data is sufficient to store the exception data, data writing module 24 may write the exception data to one or more physical regions in realm 3. For example, if the exception data requires two physical regions, and realm 3 has three physical regions available, data writing module 24 may write the exception data to realm 3. However, if data writing module 24 determines that the amount of physical regions in realm 3 that are not currently storing any data is not sufficient to store the exception data, data writing module 24 may write the exception data to one or more physical regions in a second realm (i.e., the buddy realm) that has an amount of physical regions that are not currently storing any data that is sufficient to store the exception data. For example, if the exception data requires two physical regions, and realm 3 has only one physical region available, data writing module 24 may write the exception data to realm 6, which has twenty-seven physical regions available. Note that the buddy realm does not have to be a neighboring realm.

A buddy realm is configured to store any extraneous exception data for a realm that does not have sufficient space to store the extraneous exception data. However, if the buddy realm becomes full, the original realm that needed a buddy realm can obtain a second buddy realm. Continuing the previous example, data writing module 24 may receive a request to write exception data to realm 3, the same realm that contains the I-region to which the exception data is related. Since realm 3 does not have sufficient space for more exception data, data writing module 24 may then determine whether the amount of physical regions in the buddy realm (i.e., realm 6) that are not currently storing any data is sufficient to store the exception data. If data writing module 24 determines that the amount of physical regions in realm 6 that are not currently storing any data is sufficient to store the exception data, data writing module 24 may write the exception data to one or more physical regions in realm 6. For example, if the exception data requires five physical regions, and realm 6 has eight physical regions available, data writing module 24 may write the exception data for realm 3 to realm 6. However, if data writing module 24 determines that the amount of physical regions in realm 6 that are not currently storing any data is not sufficient to store the exception data for realm 3, data writing module 24 may write the exception data to one or more physical regions in a second buddy realm that has an amount of physical regions that are not currently storing any data that is sufficient to store the exception data. For example, if the exception data requires five physical regions, and realm 6 has only three physical regions available, data writing module 24 may write the exception data to realm 2, which has twelve physical regions available. Realm 2 would then be considered another buddy realm to realm 3.

Buddy realms further help the organization of data storage 12. While the realms allow multiple, expandable E-regions, some realms may fill sooner than others due to the reduced sizes for allocation. Using buddy realms will allow a read/write head to find exception data for a full realm with minimal seek penalties, maximizing the efficiency of a hard drive that uses techniques described herein.

By partitioning data storage 12 into realms, seek penalties may be reduced by keeping writes to multiple physical regions within the same realm, where the physical regions all have a similar physical location. Further, by allowing the physical regions in each realm to be interchangeably used as an E-region, an I-region, or a spare region, techniques describe herein may provide a more flexible mechanism for expandable E-Regions and deal with FTI in a more elegant manner, which further allows smaller shingled regions to be utilized. Further, since each realm can be used as storage independently of other realms, techniques described herein may simplify defragmentation procedures and improve FTI handling. Larger streamed writes (i.e. >1 GB streamed writes) with smaller physical regions will no longer occur in the same physical regions, further improving sequential bypass performance. By dividing hard drive 6 into multiple realms, the benefits recognized by a small storage device, such as reduced seek penalties and simplified defragmentation, can be realized on a storage device with a higher storage capacity while still utilizing smaller shingled regions and smaller guard bands between the shingled regions.

The techniques described in this disclosure may be implemented, at least in part, in hardware, software, firmware, or any combination thereof. For example, various aspects of the described techniques may be implemented within one or more processing units, including one or more microprocessing units, digital signal processing units (DSPs), application specific integrated circuits (ASICs), field programmable gate arrays (FPGAs), or any other equivalent integrated or discrete logic circuitry, as well as any combinations of such components. The term “processing unit” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processing units, or other processing units, to implement one or more of the techniques described herein, such as when instructions included or encoded in the computer-readable storage medium are executed by the one or more processing units. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disk ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples of the disclosure have been described. Any combination of the described systems, operations, or functions is contemplated. These and other examples are within the scope of the following claims.

1. A storage device comprising:
a controller; and
a storage media divided into a plurality of physical regions, wherein each physical region is associated with one or more logical block addresses,
wherein the controller is configured to:
determine a plurality of realms in the storage media, wherein each realm from the plurality of realms comprises a distinct range of the logical block addresses, and wherein each physical region of the plurality of physical regions associated with a respective logical block address within the respective range of logical block addresses for the respective realm is further associated with the respective realm; and
dynamically define one or more characteristics of each physical region associated with each realm from the plurality of realms.

2. The storage device of claim 1, wherein the controller being configured to dynamically define the one or more characteristics of each physical region comprises the controller being configured to:
dynamically designate each physical region associated with each realm of the plurality realms to be one of an I-region, an E-region, or a spare physical region, wherein the E-region is configured for temporary storage, and wherein the spare physical region is a physical region of the plurality of physical regions that is configured to not store any data.

3. The storage device of claim 2, wherein the controller is further configured to:
move data written from a first physical region designated to be one of an I-region or an E-region to a first spare physical region of the one or more spare physical regions;
designate the first physical region to be a spare physical region; and
designate the first spare physical region to be an I-region or an E-region.

4. The storage device of claim 2, wherein the controller is configured to dynamically designate the one or more physical regions from the plurality of physical regions to be one of an I-region or an E-region by at least being configured to:
responsive to determining that a first physical region is not a spare physical region and that there is no data written to the first physical region, designate the first physical region to be an E-region;
responsive to determining that the first physical region is not a spare physical region and that there is temporary data or exception data written to the first physical region, designate the first physical region to be an E-region; and
responsive to determining that the first physical region is not one of a spare physical region or an E-region, designate the first physical region to be an I-region.

5. The storage device of claim 4, wherein the controller is further configure to:
write a first set of data to a second physical region, wherein the first set of data comprises non-temporary, non-exception data, and wherein the second physical region was previously designated to be an E-region; and
designate the second physical region to be an I-region.

6. The storage device of claim 1, wherein each physical region is the same size.

7. The storage device of claim 1, wherein:
the storage media is a hard disk drive comprising an inner diameter and an outer diameter,
the plurality of realms are sorted by the respective range of logical block addresses of the respective realm,
the realm associated with the smallest logical block address is physically located on the outer diameter of the hard disk drive, and
the realm associated with the largest logical block address is physically located on the inner diameter of the hard disk drive.

8. The storage device of claim 1, wherein the controller is further configured to:
receive a request to write exception data to a first realm of the plurality of realms, wherein the exception data is associated with a first physical region in the first realm;
determine an amount of physical regions in the first realm that are not currently storing any valid data;
determine whether the amount of physical regions in the first realm that are not currently storing any data is sufficient to store the exception data;
responsive to determining that the amount of physical regions in the first realm that are not currently storing any valid data is sufficient to store the exception data, write the exception data to one or more of the physical regions in the first realm that are not currently storing any valid data; and
responsive to determining that the amount of physical regions in the first realm that are not currently storing any valid data is not sufficient to store the exception data, write the exception data to a second realm of the plurality of realms, wherein the second realm has an amount of physical regions that are not currently storing any valid data that are sufficient to store the exception data.

9. The storage device of claim 8, wherein the exception data is first exception data, wherein the controller is further configured to:
receive a second request to write second exception data to the first realm of the plurality of realms;
determine an amount of physical regions in the second realm that are not currently storing any valid data;
determine whether the amount of physical regions in the second realm that are not currently storing any valid data is sufficient to store the exception data;
responsive to determining that the amount of physical regions in the second realm that are not currently storing any valid data is sufficient to store the exception data, write the exception data to one or more of the physical regions in the second realm that are not currently storing any valid data; and
responsive to determining that the amount of physical regions in the second realm that are not currently storing any valid data is not sufficient to store the exception data, write the exception data to a third realm of the plurality of realms, wherein the third realm has an amount of physical regions that are not currently storing any valid data that are sufficient to store the exception data.

10. The storage device of claim 1, wherein a first physical region is associated with a first logical block address associated with a first realm, wherein the controller device is further configured to:
update the first physical region such that the first physical region is not associated with the first logical block address and such that the first physical region is associated with a second logical block address different than the first logical block address; and
responsive to the second logical block address being associated with a second realm different than the first realm, determine that the first physical region is associated with the second realm.

11. A method comprising:
determining, by a controller of a storage device, a plurality of realms in a storage media, wherein the storage media is divided into a plurality of physical regions, wherein each physical region is associated with one or more logical block addresses, wherein each realm from the plurality of realms comprises a distinct range of the logical block addresses, and wherein each physical region of the plurality of physical regions associated with a respective logical block address within the respective range of logical block addresses for the respective realm is further associated with the respective realm; and
dynamically defining, by the controller, one or more characteristics of each physical region associated with each realm from the plurality of realms.

12. The method of claim 11, wherein dynamically defining the one or more characteristics of each physical region comprises:
dynamically designating, by the controller, each physical region in each realm of the plurality realms to be one of an I-region, an E-region, or a spare physical region, wherein the E-region is configured for temporary storage, and wherein the spare physical region is a physical region of the plurality of physical regions that is configured to not store any data.

13. The method of claim 12, further comprising:
moving, by the controller, data written from a first physical region designated to be one of an I-region or an E-region to a first spare physical region of the one or more spare physical regions;
designating, by the controller, the first physical region to be a spare physical region; and
designating, by the controller, the first spare physical region to be an I-region or an E-region.

14. The method of claim 12, wherein dynamically designating the one or more physical regions from the plurality of physical regions to be one of an I-region or an E-region comprises:
responsive to determining that a first physical region is not a spare physical region and there is no data written to the first physical region, designating, by the controller, the first physical region to be an E-region;
responsive to determining that the first physical region is not a spare physical region and that there is temporary data or exception data written to the first physical region, designating, by the controller, the first physical region to be an E-region; and
responsive to determining that the first physical region is not one of a spare physical region or an E-region, designating, by the controller, the first physical region to be an I-region.

15. The method of claim 14, further comprising:
writing, by the controller, a first set of data to a second physical region, wherein the first set of data comprises non-temporary, non-exception data, and wherein the second physical region was previously designated to be an E-region; and
designating, by the controller, the second physical region to be an I-region.

16. The method of claim 11, wherein each physical region is the same size.

17. The method of claim 11, wherein:
the storage media is a hard disk drive comprising an inner diameter and an outer diameter,
the plurality of realms are sorted by the respective range of logical block addresses of the realm,
the realm associated with the smallest logical block address is physically located on the outer diameter of the hard disk drive, and
the realm associated with the largest logical block address is physically located on the inner diameter of the hard disk drive.

18. The method of claim 11, further comprising:
receiving, by the controller, a request to write exception data to a first realm of the plurality of realms, wherein the exception data is associated with a first physical region in the first realm;
determining, by the controller, an amount of physical regions in the first realm that are not currently storing any valid data;
determining, by the controller, whether the amount of physical regions in the first realm that are not currently storing any data is sufficient to store the exception data;
responsive to determining that the amount of physical regions in the first realm that are not currently storing any valid data is sufficient to store the exception data, writing, by the controller, the exception data to one or more of the physical regions in the first realm that are not currently storing any valid data; and
responsive to determining that the amount of physical regions in the first realm that are not currently storing any valid data is not sufficient to store the exception data, writing, by the controller, the exception data to a second realm of the plurality of realms, wherein the second realm has an amount of physical regions that are not currently storing any valid data that are sufficient to store the exception data.

19. The method of claim 18, wherein the exception data is first exception data, wherein the method further comprises:
receiving, by the controller, a second request to write second exception data to the first realm of the plurality of realms;
determining, by the controller, an amount of physical regions in the second realm that are not currently storing any valid data;
determining, by the controller, whether the amount of physical regions in the second realm that are not currently storing any valid data is sufficient to store the exception data;
in response to determining that the amount of physical regions in the second realm that are not currently storing any valid data is sufficient to store the exception data, writing, by the controller, the exception data to one or more of the physical regions in the second realm that are not currently storing any valid data; and
in response to determining that the amount of physical regions in the second realm that are not currently storing any valid data is not sufficient to store the exception data, writing, by the controller, the exception data to a third realm of the plurality of realms, wherein the third realm has an amount of physical regions that are not currently storing any valid data that are sufficient to store the exception data.

20. A system comprising:
means for writing data to storage media, wherein the storage media is divided into a plurality of physical regions, wherein each physical region is associated with one or more logical block addresses;
means for determining a plurality of realms in the storage media, wherein each realm from the plurality of realms comprises a distinct range of the logical block addresses, and wherein each physical region of the plurality of physical regions associated with a respective logical block address within the respective range of logical block addresses for the respective realm is further associated with the respective realm; and
means for dynamically defining one or more characteristics of each physical region within each realm from the plurality of realms.
